(19) United States
(12) Patent Application Publication
(10) Pub. No.: US 2025/0357981 A1
(43) Pub. Date: Nov. 20, 2025

(54) PERFORMING CHANNEL STATE INFORMATION ESTIMATION AND PRECODING MATRIX INDICATOR SELECTION IN MULTI-USER, MULTIPLE INPUT, MULTIPLE OUTPUT WIRELESS COMMUNICATION NETWORKS

(71) Applicant: Dell Products L.P., Round Rock, TX (US)

(72) Inventors: Yasser AlEryani, Kanata (CA); Satish Venkob, Mississauga (CA)

(21) Appl. No.: 18/667,533

(22) Filed: May 17, 2024

(51) Int. Cl. H04B 7/06; H04B 7/0456

(52) U.S. Cl. CPC H04B 7/0626; H04B 7/0456

(57) ABSTRACT

The technology described herein is directed towards using deep reinforcement learning (DRL)-based channel state information (CSI) estimation and precoding matrix selection in user equipment. This substantially reduces signaling and computational complexity at the user equipment (UE) and base station in a multi-user equipment (multi-UE, or MU) multiple-input multiple-output (MIMO) network. The DRL-based technology also improves selection of the precoding matrix by identifying a more optimal matrix for specific network conditions, and not limiting choices to the suboptimal choices in the precoding matrices codebook lookup table. DRL agents can include a discrete action agent combined with a continuous action agent at the UE that interact to perform CSI estimation with respect to reference signals from the serving base station and interfering base stations, to determine the optimal precoding matrix for downlink data transmission. The agents also provide estimates of other CSI report measures, including the precoding matrix indicator and rank indicator.

### BACKGROUND

In wireless communications networks, multi-user, multiple input, multiple output (MU-MIMO) facilitates increased capacity, throughput, and cost per bit reduction. In MU-MIMO, different streams (in different layers) of data in separate beams are transmitted to different users using the same frequency and time resources.

Knowledge of the current radio channel state between the user equipment (UE) antennas the and antennas of a base station (e.g., gNodeB) is significant with respect to MU-MIMO and beamforming. This channel state information allows the base station to adopt the number of layers and determine how to beamform them for high capacity and throughput gains. This particularly matters for downlink transmission because the knowledge of the channel state information at the UEs is needed for the base station to decide on the number of layers, and how to pair UEs and the beamforming matrices. The channel state information is determined (estimated) by a user equipment using reference signal data sent from the serving base station, and returned in a channel state information report to the base station.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of a system/architecture for deep-reinforcement learning-based channel state information (CSI) reporting, in accordance with various example embodiments and implementations of the subject disclosure.

FIG. 2 shows an example block diagram representation of a deep reinforcement learning (DRL) system that determines a number of CSI parameters for reporting to a serving base station, in accordance with various example embodiments and implementations of the subject disclosure.

FIG. 3 shows an example block diagram representation of offline training a DRL system to learn weights for subsequent use by a UE in CSI reporting, in accordance with various example embodiments and implementations of the subject disclosure.

FIG. 4 is a flow diagram showing example operations of a user equipment, including operations related to DRL-based CSI reporting, in accordance with various example embodiments and implementations of the subject disclosure.

FIG. 5 is a flow diagram showing example operations of a user equipment, including operations for handling commands related to a DRL-based CSI reporting system, in accordance with various example embodiments and implementations of the subject disclosure.

FIG. 6 is a flow diagram showing example operations related to determining CSI report data including a precoding matrix, channel state information matrices, a precoding matrix indicator, a rank indicator, and ACK/NACK information based on environment state data, in accordance with various example embodiments and implementations of the subject disclosure.

FIG. 7 is a flow diagram showing example operations related to obtaining CSI report data from two neural network models, and communicating the CSI report data from a user equipment to a base station, in accordance with various example embodiments and implementations of the subject disclosure.

FIG. 8 is a flow diagram showing example operations related to obtaining CSI report data from combined discrete action and continuous action models, and communicating the CSI report data from a user equipment to a base station, in accordance with various example embodiments and implementations of the subject disclosure.

FIG. 9 illustrates an example block diagram of an example mobile handset operable to engage in a system architecture that facilitates wireless communications, in accordance with various example embodiments and implementations of the subject disclosure.

FIG. 10 is a block diagram representing an example computing environment into which example embodiments of the subject matter described herein may be incorporated.

FIG. 11 depicts an example schematic block diagram of a computing environment with which the disclosed subject matter can interact/be implemented at least in part, in accordance with various example embodiments and implementations of the subject disclosure.

### DETAILED DESCRIPTION

Various example embodiments of the technology described herein are generally directed towards performing channel state information (CSI) estimation and precoding matrix selection in (e.g., 5G) multi-user equipment (multi-UE, or MU) multiple-input multiple-output (MIMO) networks using multi-agent deep reinforcement learning (DRL). The DRL-based technology described herein facilitates improved efficiency and performance in MU-MIMO communication systems, including by significantly reducing signaling and computational complexity at both the UE and base station, leading to substantial power efficiency savings. Furthermore, the DRL-based technology described herein extends the selection of the precoding matrix beyond the suboptimal choices in the precoding matrices codebook (lookup table), identifying a more optimal matrix for specific network conditions. Note that codebook-based estimation by the UE is complex, and the complexity scales up exponentially with the number of transmitting and receiving antennas. Further, the codebook lookup table provides limited (relatively few) options, whereby the channel state information reported to the base station can be far from optimal with existing codebook-based estimation.

In one implementation, DRL agents at the user equipment (UE) side operate in inference mode perform the CSI estimation with respect to reference signals from the serving base station as well as interfering base stations, and to calculate the optimal precoding matrix for the serving base station to be used in the downlink data transmission. The technology described herein also includes the application of these estimates in determining other CSI report measures, including precoding matrix indicator (PMI), rank indicator (RI), and acknowledgement/negative-acknowledgement (ACK/NACK) information.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. Furthermore, the particular features, structures, or characteristics may be combined in any suitable manner in one or more embodiments/implementations. It also should be noted that terms used herein, such as “optimize,” “optimization,” “optimal” and the like only represent objectives to move towards a more optimal state, rather than necessarily obtaining ideal results. For example, “optimal” can mean the highest performing entity of what is available, rather than necessarily achieving a fully optimal result. Similarly, “maximize” means moving towards a maximal state (e.g., up to some threshold limit, if any), rather than necessarily achieving such a state.

Example embodiments of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

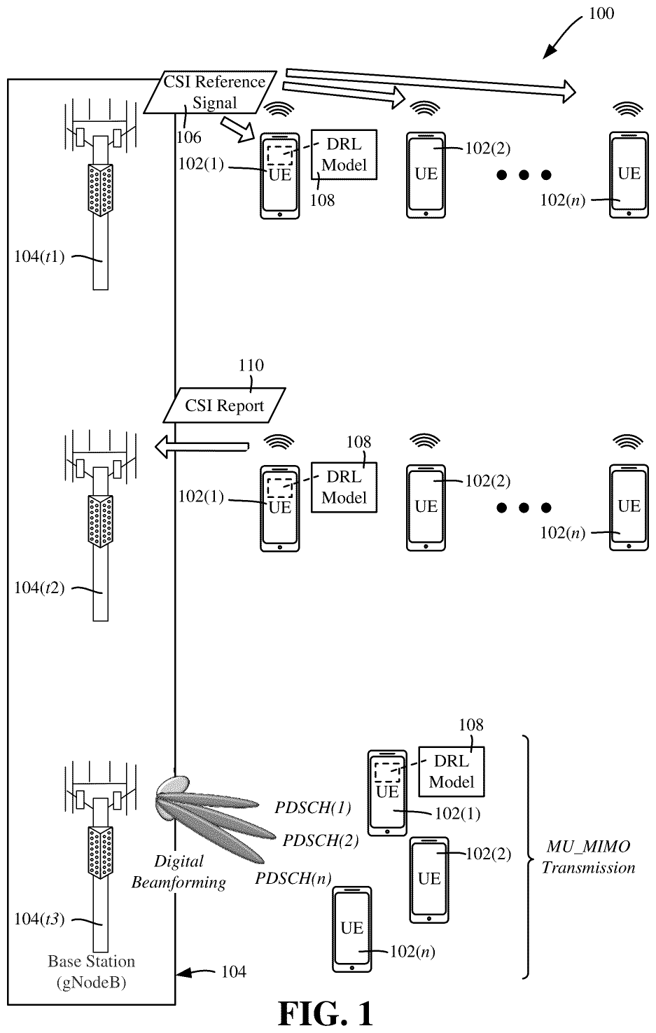

FIG. 1 is a block diagram representation of a power-efficient system/architecture 100 for channel state information (CSI) reporting. In FIG. 1, the UEs 102(1)-102(n) that are served by a base station (e.g., gNodeB) 104 receive CSI reference signal (CSI-RS) data 106 at time 11 from the base station, labeled as 104(t1) at time t1.

As described herein, using a trained artificial intelligence/machine learning (AI/ML) model, e.g., DRL model 106, the UEs estimate channel state information (CSI) from the CSI reference signal. At time 12, the UE102(1) feeds its respective CSI report back to the base station 104(t2); (note that in FIG. 1 only the UE 102(1) is depicted as having a DRL model 108 running therein for sending the CSI report 110 to the base station 104, however it is understood that each other UE can 102(2)-102(n) can be configured to operate similarly in this regard). More particularly, the channel state information (CSI) feedback from the UE provides this information to the gNB, e.g., over either PUCCH (physical uplink control channel) or PUSCH (physical uplink shared channel) channels. The CSI contains parameters including CQI (channel quality indicator), PMI (precoding matrix indicator,) rank indicator (RI) that help the base station 104 decide on the number of layers, beamforming and selecting the modulation coding scheme to use for downlink transmission.

At time 13, the base station 104(t3) performs user-pairing from the received CSI reports, and schedules physical downlink shared channel transmissions PDSCH(1) PDSCH(n) over common time and frequency resources to the paired UEs102(1)-102(n). As will be understood, the use of a DRL model provides significant benefits in massive machine-type communications type scenarios, and/or in small cells with a higher cell density and UE density situation. This is because when using conventional codebook-based CSI estimation, the UEs have to have high computational capacity and power to recommend the RI, PMI and CQI to the base station, and UEs need to run complex computational logic to derive the CSI parameters. Instead, described herein is an ML-based, low computational complexity method to calculate CQI, including in such scenarios. This technology described herein also reduces the signaling overhead and thus increases energy efficiency at the UE and at the base station.

In one implementation, an unsupervised learning scheme referred to as deep reinforcement learning (DRL) is used for determining the channel state information (CSI) parameters, avoiding the need for labeled training data as in other AI/ML systems. In general, the concept of reinforcement learning refers to the learning process of an agent interacting with its environment after receiving certain observations; the environment provides a reward to the agent for every interaction, and the reinforcement learning agent aims to select the right action for the next interaction in order to maximize the discounted reward over a time horizon. A DRL agent may be approximated by deep neural networks (trained by updating the network weights to produce the best decision policy). Once trained in this way, the DRL system described herein is able to produce optimized CSI parameters.

In one example implementation, the utilization of multiple DRL agents at the UE side perform the estimation of CSI matrices (i.e., Hᵢ, ∀ᵢ=0, . . . , K), the calculation of the precoding matrix W₀, and the calculation of CSI report measurements (PMI, RI, and CQI) for the corresponding UE. The DRL agents are divided into two categories based on the nature of action space, namely continuous or discrete action. Discrete action space includes the actions related to PMI, RI, and ACK/NACK; in problems with discrete action spaces, the agent chooses from a fixed set of possible actions. Continuous action space includes the actions related to H₀ and W₀; in problems with continuous action spaces, the agent chooses actions from a continuous range.

Discrete action space models include Deep Q-Learning (DQN), which is a model that combines Q-Learning with deep neural networks. The neural network is used to approximate the Q-function, which gives the expected future reward for taking each action in each state. The agent selects the action that maximizes the Q-function. DQN handles only discrete actions. Double DQN (DDQN) is an extension of DQN that reduces the overestimation of Q-values, a common issue in DQN, by using two networks to decouple the action selection from the target Q value generation. Dueling DQN is another variant of DQN where the architecture of the neural network is altered to separate the representation of state values and (state-dependent) action advantages.

For continuous action spaces, example actor-critic models include deep deterministic policy gradient (DDPG), an off-policy model and an adaptation of DQN for continuous action spaces. It employs the concept of an actor-critic model, utilizing two neural networks: one for the actor, which updates the policy, and another for the critic, which estimates the value function. Proximal policy optimization (PPO) is a policy gradient method which aims to keep the new policy close to the old policy during update by adding a constraint to the objective function. Although it was designed for continuous action spaces, it can also be used with discrete action spaces. Soft actor-critic (SAC) is an off-policy model that aims to maximize the expected return and entropy of the policy concurrently. It is a form of an actor-critic method specifically designed for continuous action spaces and is considered state-of-the-art in terms of performance and efficiency.

The differences between DRL models for discrete and continuous action spaces are based on how they handle action selection. For discrete action spaces, the neural network generally outputs a probability distribution over the set of possible actions, and the action is selected based on this distribution. This is often done using a softmax function. For continuous action spaces, the neural network can output the parameters of a continuous probability distribution from which actions are sampled. For example, in DDPG, the actor network directly outputs the action (from a deterministic policy), while in SAC, the actor network outputs the mean and standard deviation of a Gaussian distribution from which the action is sampled.

Note that while many models can be adapted to handle either discrete or continuous actions, they may not perform equally well in both cases. For example, DQN, which was designed for discrete action spaces, may struggle with high-dimensional or continuous action spaces. As such, the example implementation described herein implements discrete agents for optimizing PMI, RI, and ACK/NACK, and continuous agents for optimizing W₀ and H₀.

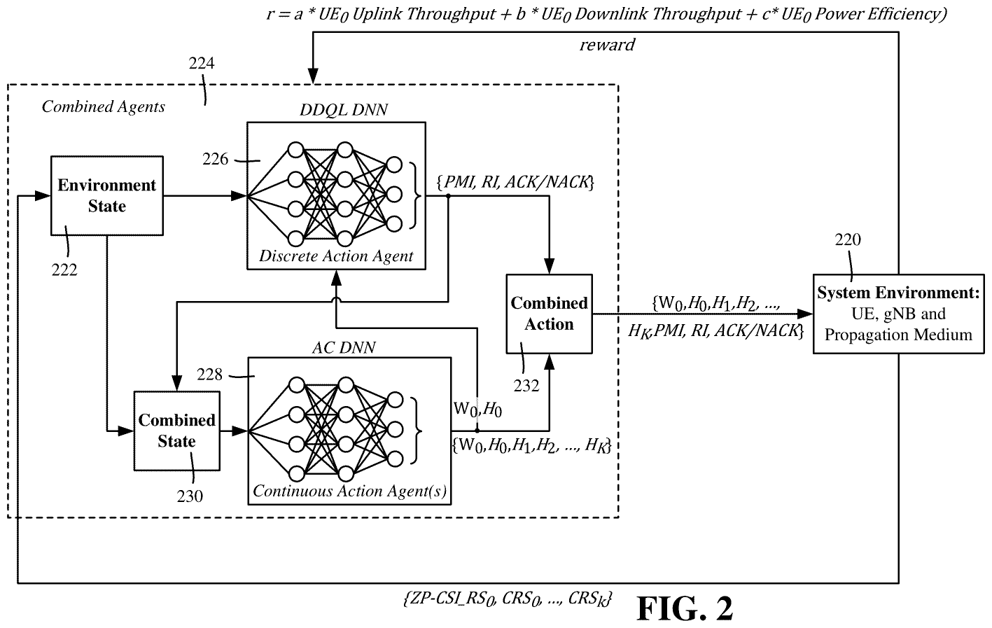

In one example implementation, for discrete action spaces, the utilization of a single agent with double deep Q-learning model is used to produce optimized discrete action vectors upon training, as described with reference to FIG. 2. In this example implementation, for continuous action spaces, the utilization of one or more actor-critic models is described herein, such as policy gradient (PG), actor-critic (AC) or deep double policy gradient algorithm (DDPG), each of which can be used. These kinds of models perform efficiently in producing actions with continuous spaces, under the utilization of the actor-critic learning concept.

FIG. 2 shows deep neural network-based reinforcement learning to converge on an optimal CQI and precoding matrix W₀. In FIG. 2, the system environment 220 provides the source of environment state data 222 input to the models (combined agents) 224. The DRL system in the example of FIG. 2 is a combination of a group of interacting agents 226 and 228 each responsible for a subset of actions. The environment state data 222 includes a zero power channel state information reference signal (ZP_CSI_RS₀) of the serving base station, and cell-specific reference signals (CRS₀, . . . , CRSₖ) of k interfering base stations.

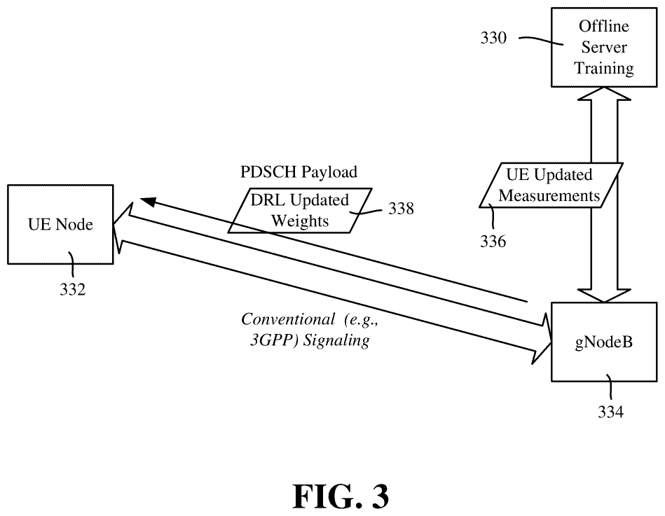

As shown in the example implementation of FIG. 2, the technology described herein, based on a combined agent 224 of two interacting DRL agents 226 and 228, produces the CSI report data. More particularly, during inferencing the discrete action agent 226, which has previously learned its weights based on a reward function (as described herein) during separate offline training, outputs the {PMI, RI, ACK/NACK} portion of the CSI-report. With the number of PMI, RI and ACK/NACK determined, the continuous action agent 228, which has also learned its own weights based on the reward function during offline training, inputs combined state data 230 including the current environment state data 222 {ZP_CSI_RS₀, CRS₀, . . . , CRSₖ} along with the PMI, RI and ACK/NACK information. Based on the combined state data 230, the DRL agent 228 outputs the precoding matrix W₀ and the CSI matrices H₀, H₁, H₂, . . . , H_{K}. Note that W₀ and H₀ can be fed back to the discrete action agent 226, e.g., during training as described below with reference to FIG. 3.

The combined action (block 232) output, that is, {W₀, H₀, H₁, H₂, . . . , H_{K}, PMI, RI, ACK/NACK}, is then sent in the channel state information report to the serving base station gNB₀, (e.g., through radio resource control signaling). This is used by the gNB₀ to optimize downlink data transmission for the user equipment running the combined agents 224.

Offline training at a server 330, for a UE node 332 (e.g., deployed for training purposes) coupled to a gNodeB 334, is generally represented in FIG. 3. In general, the DRL model (the combined agents) is trained offline within a remote server 330 (e.g., at the cloud or gNB location) that is attached to the gNodeB 334. Once trained, the adapted weights of both discrete and continuous agents are transmitted to the UE 332 through usual PUSCH payload signaling.

As shown in the example of FIG. 3, the gNodeB 334 provides updated UE measurements 336 (e.g., including the environment state data) obtained by the UE node 332 (and, for example, similar measurements from other UEs deployed in various network conditions). During training, once the combined agents of the DNN network receive a certain accumulated reward, and a state vector, the weights of the neural networks are updated (block 338) according to the instantaneous reward (based on gradient descent algorithm). Upon the adaptation of the neural network weights, the agents produce an optimized decision in a CSI-report as described herein that is sent back to the serving gNB 334.

Upon reception of CSI-report actions, the gNB 334 sets its configurations accordingly (including modulation scheme, code rate, precoding matrices, and the like). This results in a new performance level, and hence a new instantaneous reward value. The reward function, in this case, is a weighted sum of the UE downlink throughput, uplink throughput, and UE power efficiency. Upon reception of updated reward values as well as reference signals (CSI-RS from serving gNB and CRS from both serving gNB as well as interfering gNBs), the UE triggers a new training episode to produce new CSI matrix estimates as well as a new CSI-Report. This is accompanied by weight adjustments for the agents neural network.

The table below shows detailed DRL design parameters and its system equivalent:

| Environment Variables | | System Equivalent |
|---|---|---|
| Contin- uous Action Agent | State S_{cont}. Reward r Action a_{cont}. | {CSI - RS symbols, CSI - Report values} $f ( \begin{matrix}{UE}_{0} UL throughtput , {UE}_{0} DL throughput , \\ {UE}_{0} power efficiency\end{matrix} )$ {W₀, H₀, . . . , H_{K}} |
| Discrete Action Agent | State S_{disc}. Reward r_{disc}. Action a_{disc}. | {CSI - RS symbols, W₀ H₀} $f ( \begin{matrix}{UE}_{0} UL throughtput , {UE}_{0} DL throughput , \\ {UE}_{0} power efficiency\end{matrix} )$ CSI - Report (UE₀) = {PMI, RI, ACK/NACK} |

As indicated in the above table, one suitable reward function may be defined as:

$$\begin{matrix}reward = a * UE\_ 0 UL Throughput + b * UE\_ 0 DL Throughput + c * \\ UE\_ 0 Power Efficiency .\end{matrix}$$

where (a, b, c)>0 and a+b+c=1.

The technology described herein also includes the ability to target a certain performance metric based on reward function biasing:
For uplink throughput-biased design, the value of a is given more value in the weighted combination relative to b, c.
Similarly, for downlink throughput-biased design, the value of b is given more value in the weighted combination relative compared to a, c.
For energy-efficient system design, c>(a, b).

Once the reward weighting parameters are set, the agents learn the best action that maximizes the accumulative reward, in the long run. Note that both the DDQL DNN and the actor-critic DNN are interacting during the training session, which is achieved by using the output of each network as an input to the other one along with its assigned state vectors (the received CSI-RS symbols in our case).

When offline training is completed, e.g., a stopping criterion is met, e.g., the DRL network is considered sufficiently converged, the two sets of weights for the two agents (discrete action agent and continuous action agent(s)) are known. These are sent to the user equipment, which updates its corresponding models based on the new weights.

Note that convergence can be impacted by the cardinality of the action spaces as well as the domain of each action element. Further, DRL systems need to be trained in a way that avoids any ‘overtrained’ scenario in which the performance of the DRL system reaches its maximum value and then starts to degrade as a results of continuous “unnecessary” training.

In general, the user equipment operates with the models in inference mode until new weights are obtained, at which time the models are updated again, and so on. Note that the transmission of the sets of weights is relatively fast, and inference to obtain a decision is on the order of milliseconds. Training, however, can take some time, and a base station can observe if there is significant degradation of the network during ongoing inferencing, and/or performance of a UE has dropped for some reason, e.g., its updated weights are not appropriate for a current network scenario (e.g., one not previously encountered and thus not learned by the models). This can be detected based on the expected reward (e.g., higher downlink throughput) not being met; channel quality reports also can be evaluated for poor signal quality. If this occurs, the base station can direct the UE to turn off use of DRL-based CSI estimation, and return to the conventional (codebook-based) estimation. Although not desirable for efficiency, network performance can be improved until the updated model weights are learned, at which point the newly learned weights can be sent to the user equipment along with an indication to switch back to DRL-based CSI reporting.

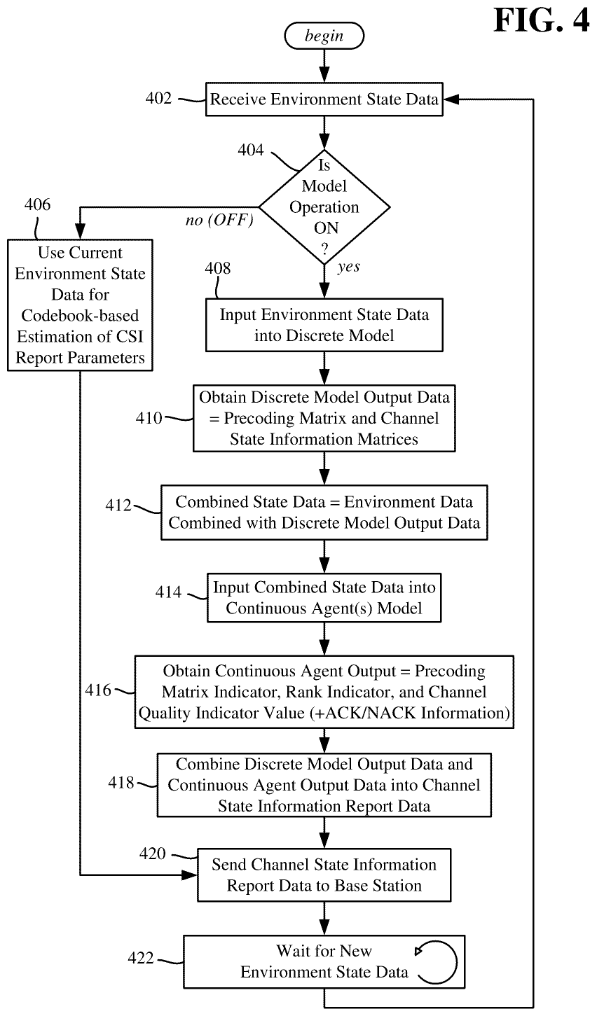

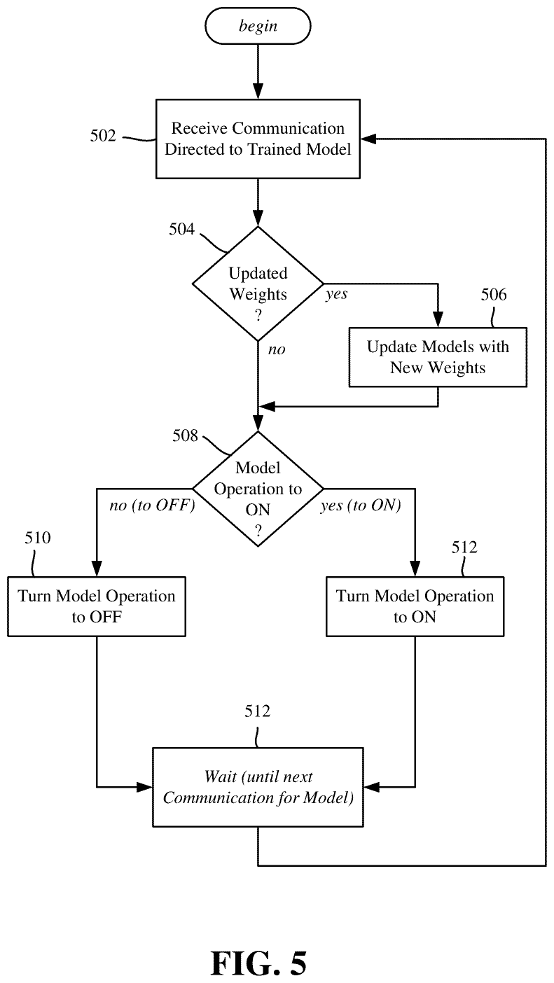

FIG. 4 is a flow diagram showing example operations of a UE with respect to combined agents for DRL-based CSI estimation, beginning at operation 402 which represents the UE receiving the environment state data (the reference signals) from the base station and any interfering base stations. Operation 404 evaluates whether the DRL model is on, or has been turned off, e.g., while learning new weights with new data is occurring and the existing weights for the models are providing inadequate performance. If turned off, operation 406 represents using current environment state data for codebook-based estimation of CSI report parameters, which is sent via operation 420 to the base station. The process of FIG. 4 then waits for new environment state data; note however that DRL model inferencing may be turned back on (e.g., FIG. 5) before the new environment state data is received.

If the DRL model is on in the inference mode, operation 408 inputs the environment state data into the discrete action agent (discrete model). Operation 410 obtains the discrete action agent output data that includes the precoding matrix of the serving base station and channel state information matrices of the serving base station and any interfering base stations.

Operation 412 represents combining the environment state data with the discrete model output data. Operation 414 inputs the combined state data into the continuous agent model. Operation 416 represents obtaining the continuous agent model output including the precoding matrix indicator, rank indicator, and channel operation quality indicator value (and ACK/NACK information).

Operation 418 combines the discrete action agent model output data and continuous agent model output data into channel state information report data, which is sent via operation 420 to the base station. Operation 422 waits for new environment state data, which when received (operation 402) starts the process over.

FIG. 5 is a flow diagram showing example operations of a user equipment with respect to receiving control information from the base station related to the DRL agents, beginning at operation 502 where a communication directed to trained model is received, e.g., by a simple message or MAC PDUs (media access control protocol data units/control elements) within the data payload. If the communication is directed to sets of updated weights, operation 504 branches to operation 506 where the models are updated with the new weights. This communication may correspond to an implicit (turn DRL inferencing on as soon as the new weights are applied) or an explicit command to turn the model on, if not already on.

Operation 508 evaluates for whether the model is to be turned on or off, whether by an explicit command or implicit action to turn the model on in conjunction with having received new weights. Operation 510 turns the model off if directed, or operation 512 turns the model on (if not already on). Operation 512 represents waiting until any next communication directed to control/update of the model is received.

To summarize, the utilization of DRL AI technology efficiently performs the CSI estimation at the UE side (in the downlink). Note that the AI agents are assumed to be conducting at the UE side; however, for energy saving for the UE (as well as the gNB), the training of the AI agents is done prior to installation at the UE node, either at the gNB or at any external CPU. Once trained, AI agent weight parameters are delivered to the UE, e.g., through an application feature. Once trained, the DRL model can generate a virtually immediate output for every given input, without going through any of the training procedures, as with typically deployed DRL systems. In other words, once trained, the DRL system is deployed in UE hardware and can operate directly in the inference mode, during which the DRL neural agents can generate a virtually immediate optimized output (H, PMI, RI, and CQI), for any given configuration and any given propagation media.

Thus, for downlink CSI matrix estimation, the continuous action agent receives a set of preconfigured orthonormal sequences (CSI-RS symbols) and uses the set to predict the new H matrix, as shown in FIG. 2. The output results in an optimized CSI report generated as a function of the discrete agent (DDQL DNN) model.

Turning to complexity analysis of DRL system, consider that a conventional UE has to conduct CSI estimation, precoding and CSI-report through traditional estimation algorithms and codebook lookup tables (for finding the W matrix). The complexity behind such a procedure is extremely high, resource-intensive and energy-intensive.

For a well-trained DRL network (operating on the inference mode), the complexity of computing optimized output of H, W, and other CSI report variables can be computed as follows:
for any fully connected layer Lᵢ of input size lᵢ and output size Oᵢ, the number of FLOPs (floating point operations per second) is given by:

$$FLOPs ( {L}_{i} ) = 2 {I}_{i} {O}_{i} .$$

Accordingly, for each continuous action network, the state space S is of size |I_{i,con.}|=|S_{i,con.}|=|CSI-RS|+|CSI-Report|=P+3, where P represents the overall number of orthonormal sequences received by the gNB. The output size of the continuous action DRL system is given by

$${O}_{i , con .} = \vert {W}_{o} \vert + {\sum }_{k = 0}^{K} \vert {H}_{k} \vert = 2 ( {M}_{0} \times {N}_{0} ) + {\sum }_{k = 1}^{K} ( {M}_{k} \times {N}_{k} ) .$$

Similarly, the input and output sizes of the discrete DRL network can be given respectively as |l_{i,dis.}|=|CSI-RS|+|W₀×H₀|=P+(Nₒ×Mₒ), and | O_{i,dis.}|=|CSI−Report|=3. Accordingly, if standard DRL networks of two hidden layers of size 256 and 128 are used, for example, the total number of FLOPs of the DRL-based method during the inference is given by:

$$\begin{matrix}{FLOPs}_{DRL} = {FLOPs}_{cont .} + {FLOPs}_{disc .} \\ = {\sum }_{i = 1}^{3} {FLOPs}_{cont .} ( {L}_{i} ) + {\sum }_{i = 1}^{3} {FLOPs}_{disc .} ( {L}_{i} )\end{matrix}$$

As can be seen in the equation above, the computational complexity of DRL system is a mere linear equation of the number of antennas as well as the cardinality of CSI-RS signals. In conventional systems the minimum complexity is a square value of these factors, which introduces a significant (exponentially increasing) computational complexity as the number of UEs and/or antenna sizes increases. This makes the technology described herein very applicable to massive machine type communications.

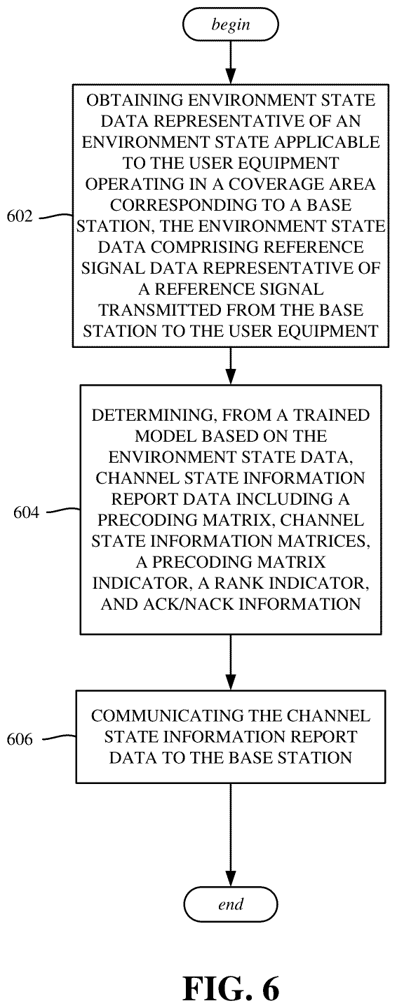

One or more example embodiments can be embodied in a user equipment, such as represented in the example operations of FIG. 6, and for example can include a memory that stores computer executable components and/or operations, and a processor that executes computer executable components and/or operations stored in the memory. Example operations can include operation 602, which represents obtaining environment state data representative of an environment state applicable to the user equipment operating in a coverage area corresponding to a base station, the environment state data comprising reference signal data representative of a reference signal transmitted from the base station to the user equipment. Example operation 604 represents determining, from a trained model based on the environment state data, channel state information report data, which can include a precoding matrix, channel state information matrices, a precoding matrix indicator, a rank indicator, and ACK/NACK information. Example operation 606 represents communicating the channel state information report data to the base station.

The reference signal data can include channel state information reference signal data.

The reference signal can include cell-specific reference signal data of at least one interfering base station.

The trained model can include a deep reinforcement learning model. The deep reinforcement learning model can include a double deep Q-network that can include first weight data representative of first weights learned based on a reward function comprising a weighted combination of uplink throughput data representative of an uplink throughput corresponding to communication with the base station, downlink throughput data representative of a downlink throughput corresponding to communication with the base station, and power efficiency data representative of a power efficiency corresponding to communication with the base station, and an actor-critic deep neural network model having second weight data representative of second weights learned based on the reward function. The deep reinforcement learning model can include a discrete action agent and a continuous action agent, and determining the channel state information report data can include inputting the environment state data to the discrete action agent to obtain the precoding matrix indicator, the rank indicator, and the ACK/NACK information from an output of the discrete action agent, and inputting combined state data, comprising the environment state data and the precoding matrix indicator, the rank indicator, and the ACK/NACK information obtained from the output of the discrete action agent, into the continuous action agent to obtain the precoding matrix, and the channel state information matrices, from one or more respective outputs of the continuous action agent.

Further operations can include combining the precoding matrix indicator, the rank indicator, and the ACK/NACK information from the output of the discrete action agent, with the precoding matrix and the channel state information matrices, from the one or more respective outputs of the continuous action agent, into an uplink communication used to communicate the channel state information report data to the base station.

Further operations can include inputting the precoding matrix, and at least one of the channel state information matrices into the discrete action agent.

Further operations can include obtaining first weights representative of first weights for the discrete action agent, learned in an offline training system based on a reward function comprising a weighted combination of uplink throughput data representative of an uplink throughput corresponding to communication with the base station, downlink throughput data representative of a downlink throughput corresponding to communication with the base station, and power efficiency data representative of a power efficiency corresponding to communication with the base station, and obtaining second weights representative of second weights for the continuous action agent, learned in the offline training system, based on the reward function.

Further operations can include updating the discrete action agent with the first weights, and updating the continuous action agent with the second weights. The reward function can be a first reward function corresponding to a first weighted combination that assigns more relative weight to the power efficiency data; further operations can include obtaining third weights representative of learned third weight data for the discrete action agent, learned in the offline training system based on a second reward function comprising a second weighted combination of the uplink throughput data, the downlink throughput data, and the power efficiency data that decreases the relative weight assigned to the power efficiency data relative to the first weighted combination, obtaining one or more fourth weights representative of learned fourth weight data for the continuous action agent, learned in the offline training system, based on the second reward function, updating the discrete action agent with the third weights, and updating the at least one continuous action agent with the fourth weights.

The channel state information report data can be first channel state information report data; further operations can include receiving a first communication indicating that the trained model is not to be used, and in response to the first communication, using codebook-based estimation to determine second channel state information report data, and communicating the second channel state information report data to the base station, receiving a second communication indicating that the trained model is to be used, and in response to the second communication, resuming use of the trained model for determining third channel state information report data, and communicating the third channel state information report data to the base station.

Further operations can include, prior to the determining of the third channel state information report, receiving updated weight data for the trained model, and applying the updated weight data to obtain an updated instance of the trained model; resuming the use of the trained model can include using the updated instance of the trained model for the determining of the third state information report data.

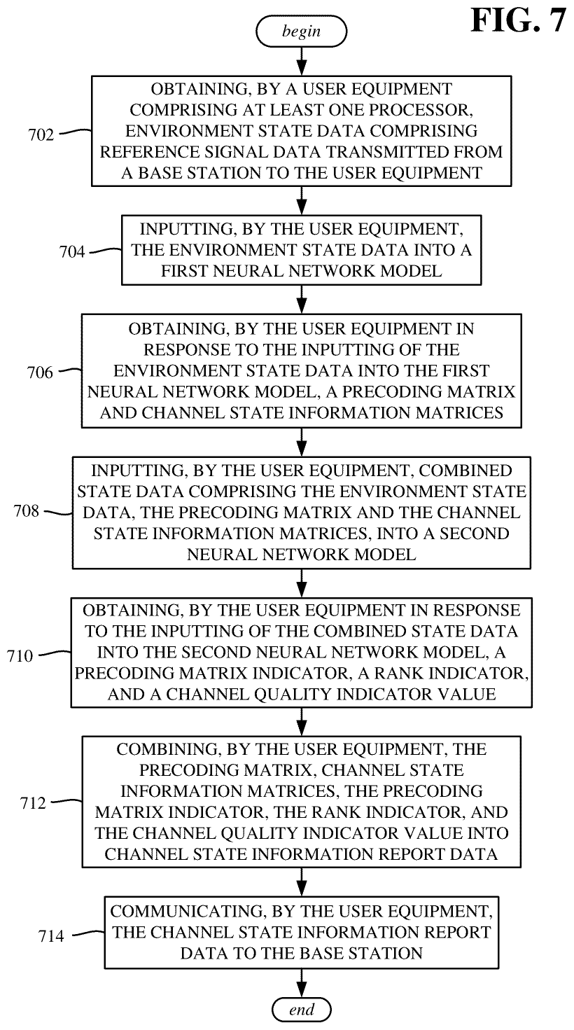

One or more example embodiments, such as corresponding to example operations of a method, are represented in FIG. 7. Example operation 702 represents obtaining, by a user equipment comprising at least one processor, environment state data comprising reference signal data transmitted from a base station to the user equipment. Example operation 704 represents inputting, by the user equipment, the environment state data into a first neural network model. Example operation 706 represents obtaining, by the user equipment in response to the inputting of the environment state data into the first neural network model, a precoding matrix and channel state information matrices. Example operation 708 represents inputting, by the user equipment, combined state data comprising the environment state data, the precoding matrix and the channel state information matrices, into a second neural network model. Example operation 710 represents obtaining, by the user equipment in response to the inputting of the combined state data into the second neural network model, a precoding matrix indicator, a rank indicator, and a channel quality indicator value. Example operation 712 represents combining, by the user equipment, the precoding matrix, channel state information matrices, the precoding matrix indicator, the rank indicator, and the channel quality indicator value into channel state information report data. Example operation 714 represents communicating, by the user equipment, the channel state information report data to the base station.

Further operations can include obtaining, by the user equipment in response to the inputting of the combined state data into the second neural network model, ACK/NACK information, and adding, by the user equipment, the ACK/NACK information to the channel state information report data for communicating to the base station.

Inputting the environment state data into the first neural network model can include inputting the environment state data into a first deep reinforcement network agent comprising a double deep-Q network, and inputting the combined state data into the second neural network model can include inputting the environment state data into second deep reinforcement network agent comprising an actor-critic deep neural network.

The first neural network model can include a discrete action agent, the second neural network model can include continuous action agent, and further operations can include obtaining, by the user equipment, first weights for the discrete action agent learned in an offline training system based on a reward function comprising a weighted combination of uplink throughput data, downlink throughput data, and power efficiency data, obtaining, by the user equipment, second weights for the continuous action agent based on the reward function, updating, by the user equipment, the discrete action agent based on the first weights, and updating, by the user equipment, the continuous action agent based on the second weights.

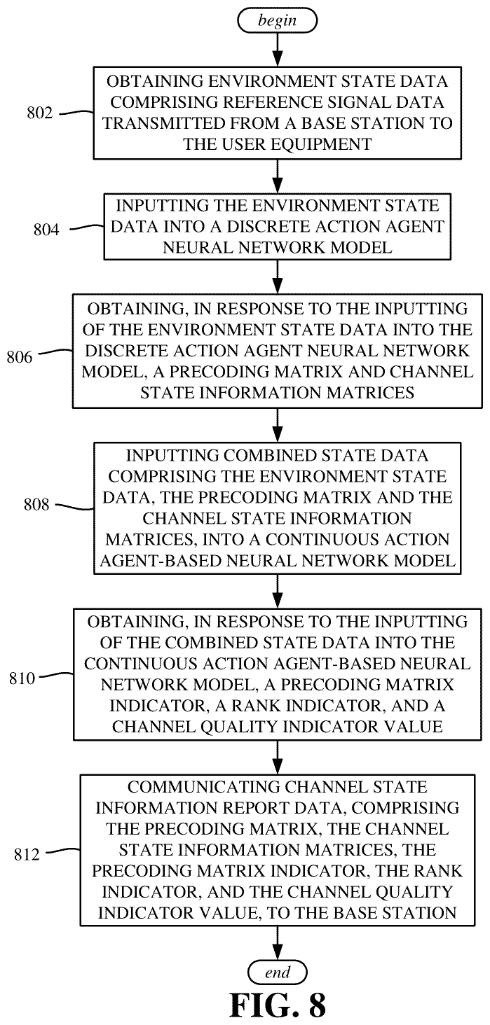

FIG. 8 summarizes various example operations, e.g., corresponding to a machine-readable medium, comprising executable instructions that, when executed by a processor of a user equipment, facilitate performance of operations. Example operation 802 represents obtaining environment state data comprising reference signal data transmitted from a base station to the user equipment. Example operation 804 represents inputting the environment state data into a discrete action agent neural network model. Example operation 806 represents obtaining, in response to the inputting of the environment state data into the discrete action agent neural network model, a precoding matrix and channel state information matrices. Example operation 808 represents inputting combined state data comprising the environment state data, the precoding matrix and the channel state information matrices, into a continuous action agent-based neural network model. Example operation 810 represents obtaining, in response to the inputting of the combined state data into the continuous action agent-based neural network model, a precoding matrix indicator, a rank indicator, and a channel quality indicator value. Example operation 812 represents communicating channel state information report data, comprising the precoding matrix, the channel state information matrices, the precoding matrix indicator, the rank indicator, and the channel quality indicator value, to the base station.

Further operations can include obtaining first weights for the discrete action agent neural network model learned via offline training in a server external to the user equipment, obtaining second weights for the continuous action agent-based neural network model learned via the offline training in the server, updating the discrete action agent neural network model based on the first weights, and updating the continuous action agent-based neural network model based on the second weights.

The environment state data can include first environment state data comprising first reference signal data, the precoding matrix can be a first precoding matrix, the channel state information matrices can be first channel state information matrices, the combined state data can include first combined state data, the precoding matrix indicator can be a first precoding matrix indicator, the rank indicator can be a first rank indicator, the channel quality indicator value can be a first channel quality indicator value, the channel state information report data can include first channel state information report data, and further operations can include obtaining second environment state data comprising second reference signal data transmitted from the base station to the user equipment, inputting the second environment state data into the discrete action agent neural network model, obtaining, in response to the inputting of the second environment state data into the discrete action agent neural network model, a second precoding matrix and second channel state information matrices, inputting second combined state data comprising the second environment state data, the second precoding matrix and the second channel state information matrices, into the continuous action agent-based neural network model, obtaining, in response to the inputting of the second combined state data into the continuous action agent-based neural network model, a second precoding matrix indicator, a second rank indicator, and a second channel quality indicator value, and communicating second channel state information report data, comprising the second precoding matrix, the second channel state information matrices, the second precoding matrix indicator, the second rank indicator, and the second channel quality indicator value, to the base station.

As can be seen, the technology described herein facilitates the reduction of signaling and computational complexity at both the UE and base station, leading to substantial power efficiency savings. Furthermore, the technology extends the selection of the precoding matrix beyond the suboptimal choices in the precoding matrices lookup table, enabling the identification of a more optimal matrix for specific network conditions. The DRL-based solution described herein offers significant improvements in the efficiency and performance of 5G Multi-UE MIMO communication systems.

More particularly, the utilization of a multi-agent DRL system, operating in an inference mode to estimate the CSI matrices and other elements of CIS-report by approximating any complicated non-linear equation into a set of weighted some semi-linear equations, results in a significant increase in energy efficiency from the significant reduction on the computational complexity at the UE. The AI model as described herein is thus a very efficient solution for downlink CSI estimation method using CSI-RS signaling, reducing the need for powerful processing capabilities and large power consumption at the UE side, which are significant considerations.

Turning to general concepts, as used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

A wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms of the number of transmit (M) and the number of receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

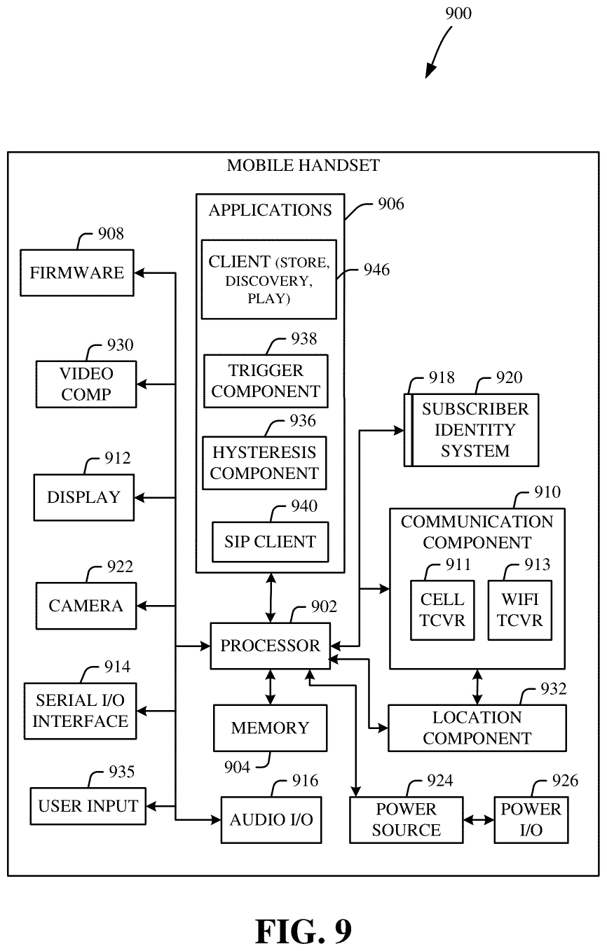

Referring now to FIG. 9, illustrated is a schematic block diagram of an example end-user device such as a user equipment) that can be a mobile device 900 capable of connecting to a network in accordance with some embodiments described herein. Although a mobile handset 900 is illustrated herein, it will be understood that other devices can be a mobile device, and that the mobile handset 900 is merely illustrated to provide context for the embodiments of the various embodiments described herein. The following discussion is intended to provide a brief, general description of an example of a suitable environment 900 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media.

Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 900 includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 and/or the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks.

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 1394) through a hardwire connection, and other serial input devices (e.g., a keyboard, keypad, and mouse). This supports updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communication component 910 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 922 (e.g., a camera) can be provided for decoding encoded multimedia content. The video processing component 922 can aid in facilitating the generation, editing and sharing of video quotes. The handset 900 also includes a power source 924 in the form of batteries and/or an AC power subsystem, which power source 924 can interface to an external power system or charging equipment (not shown) by a power I/O component 926.

The handset 900 can also include a video component 930 for processing video content received and for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touch screen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 938 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 810, includes an indoor network radio transceiver 913 (e.g., Wi-Fi transceiver). This function supports the indoor radio link, such as IEEE 802.11, for the dual-mode GSM handset 900. The handset 900 can accommodate at least satellite radio services through a handset that can combine wireless voice and digital radio chipsets into a single handheld device.

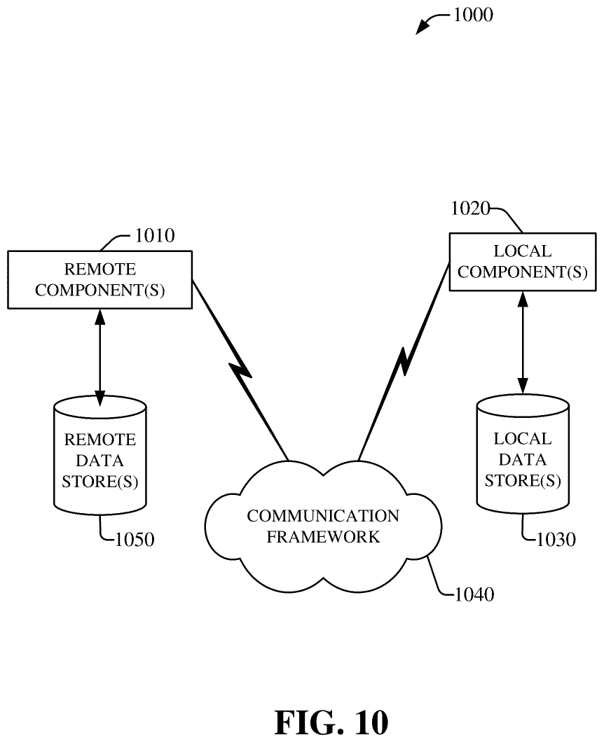

FIG. 10 is a schematic block diagram of a computing environment 1000 with which the disclosed subject matter can interact. The system 1000 comprises one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices). In some embodiments, local component(s) 1020 can comprise an automatic scaling component and/or programs that communicate/use the remote resources 1010, etc., connected to a remotely located distributed computing system via communication framework 1040.

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

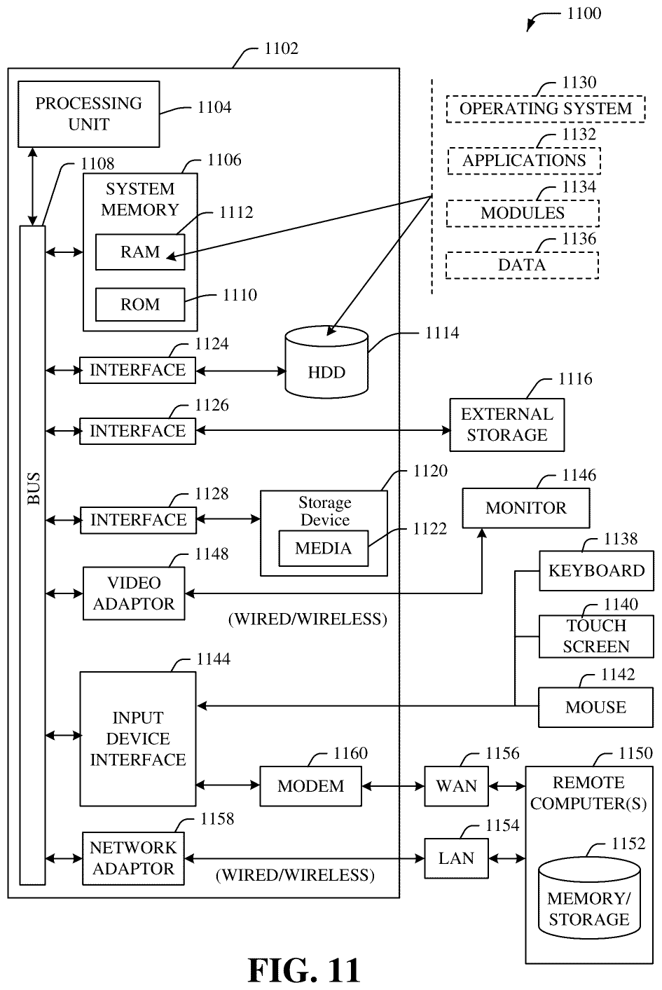

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the example embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), and can include one or more external storage devices 1116 (e.g., a magnetic floppy disk drive (FDD) 1116, a memory stick or flash drive reader, a memory card reader, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114.

Other internal or external storage can include at least one other storage device 1120 with storage media 1122 (e.g., a solid state storage device, a nonvolatile memory device, and/or an optical disk drive that can read or write from removable media such as a CD-ROM disc, a DVD, a BD, etc.). The external storage 1116 can be facilitated by a network virtual machine. The HDD 1114, external storage device(s) 1116 and storage device (e.g., drive) 1120 can be connected to the system bus 1108 by an HDD interface 1124, an external storage interface 1126 and a drive interface 1128, respectively.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1194 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A user equipment, comprising:
a processor; and
a memory that stores executable instructions that, when executed by the processor, facilitate performance of operations, the operations comprising:
obtaining environment state data representative of an environment state applicable to the user equipment operating in a coverage area corresponding to a base station, the environment state data comprising reference signal data representative of a reference signal transmitted from the base station to the user equipment;
determining, from a trained model based on the environment state data, channel state information report data comprising a precoding matrix, channel state information matrices, a precoding matrix indicator, a rank indicator, and ACK/NACK information; and
communicating the channel state information report data to the base station.

2. The user equipment of claim 1, wherein the reference signal data comprises channel state information reference signal data.

3. The user equipment of claim 1, wherein the reference signal data comprises cell-specific reference signal data of at least one interfering base station.

4. The user equipment of claim 3, wherein the trained model comprises a deep reinforcement learning model.

5. The user equipment of claim 4, wherein the deep reinforcement learning model comprises a double deep Q-network comprising first weight data representative of first weights learned based on a reward function comprising a weighted combination of uplink throughput data representative of an uplink throughput corresponding to communication with the base station, downlink throughput data representative of a downlink throughput corresponding to communication with the base station, and power efficiency data representative of a power efficiency corresponding to communication with the base station, and an actor-critic deep neural network model having second weight data representative of second weights learned based on the reward function.

6. The user equipment of claim 4, wherein the deep reinforcement learning model comprises a discrete action agent and a continuous action agent, and wherein the determining of the channel state information report data comprises:
inputting the environment state data to the discrete action agent to obtain the precoding matrix indicator, the rank indicator, and the ACK/NACK information from an output of the discrete action agent, and
inputting combined state data, comprising the environment state data and the precoding matrix indicator, the rank indicator, and the ACK/NACK information obtained from the output of the discrete action agent, into the continuous action agent to obtain the precoding matrix, and the channel state information matrices, from one or more respective outputs of the continuous action agent.

7. The user equipment of claim 6, wherein the operations further comprise combining the precoding matrix indicator, the rank indicator, and the ACK/NACK information from the output of the discrete action agent, with the precoding matrix and the channel state information matrices, from the one or more respective outputs of the continuous action agent, into an uplink communication used to communicate the channel state information report data to the base station.

8. The user equipment of claim 6, wherein the operations further comprise inputting the precoding matrix, and at least one of the channel state information matrices into the discrete action agent.

9. The user equipment of claim 6, wherein the operations further comprise obtaining first weights representative of first weights for the discrete action agent, learned in an offline training system based on a reward function comprising a weighted combination of uplink throughput data representative of an uplink throughput corresponding to communication with the base station, downlink throughput data representative of a downlink throughput corresponding to communication with the base station, and power efficiency data representative of a power efficiency corresponding to communication with the base station, and obtaining second weights representative of second weights for the continuous action agent, learned in the offline training system, based on the reward function.

10. The user equipment of claim 9, wherein the operations further comprise updating the discrete action agent with the first weights, and updating the continuous action agent with the second weights.

11. The user equipment of claim 10, wherein the reward function is a first reward function corresponding to a first weighted combination that assigns more relative weight to the power efficiency data, and wherein the operations further comprise:
obtaining third weights representative of learned third weight data for the discrete action agent, learned in the offline training system based on a second reward function comprising a second weighted combination of the uplink throughput data, the downlink throughput data, and the power efficiency data that decreases the relative weight assigned to the power efficiency data relative to the first weighted combination,
obtaining one or more fourth weights representative of learned fourth weight data for the continuous action agent, learned in the offline training system, based on the second reward function,
updating the discrete action agent with the third weights, and
updating the at least one continuous action agent with the fourth weights.

12. The user equipment of claim 1, wherein the channel state information report data is first channel state information report data, and wherein the operations further comprise:
receiving a first communication indicating that the trained model is not to be used, and
in response to the first communication, using codebook-based estimation to determine second channel state information report data, and communicating the second channel state information report data to the base station;
receiving a second communication indicating that the trained model is to be used, and
in response to the second communication, resuming use of the trained model for determining third channel state information report data, and communicating the third channel state information report data to the base station.

13. The user equipment of claim 12, wherein the operations further comprise, prior to the determining of the third channel state information report, receiving updated weight data for the trained model, and applying the updated weight data to obtain an updated instance of the trained model, and wherein the resuming of the use of the trained model comprises using the updated instance of the trained model for the determining of the third state information report data.

14. A method, comprising:
obtaining, by a user equipment comprising at least one processor, environment state data comprising reference signal data transmitted from a base station to the user equipment;
inputting, by the user equipment, the environment state data into a first neural network model;
obtaining, by the user equipment in response to the inputting of the environment state data into the first neural network model, a precoding matrix and channel state information matrices;
inputting, by the user equipment, combined state data comprising the environment state data, the precoding matrix and the channel state information matrices, into a second neural network model;
obtaining, by the user equipment in response to the inputting of the combined state data into the second neural network model, a precoding matrix indicator, a rank indicator, and a channel quality indicator value;
combining, by the user equipment, the precoding matrix, channel state information matrices, the precoding matrix indicator, the rank indicator, and the channel quality indicator value into channel state information report data; and
communicating, by the user equipment, the channel state information report data to the base station.

15. The method of claim 14, further comprising obtaining, by the user equipment in response to the inputting of the combined state data into the second neural network model, ACK/NACK information, and adding, by the user equipment, the ACK/NACK information to the channel state information report data for communicating to the base station.

16. The method of claim 14, wherein the inputting of the environment state data into the first neural network model comprises inputting the environment state data into a first deep reinforcement network agent comprising a double deep-Q network, and wherein the inputting of the combined state data into the second neural network model comprises inputting the environment state data into second deep reinforcement network agent comprising an actor-critic deep neural network.

17. The method of claim 14, wherein the first neural network model comprises a discrete action agent, wherein the second neural network model comprises continuous action agent, and further comprising:
obtaining, by the user equipment, first weights for the discrete action agent learned in an offline training system based on a reward function comprising a weighted combination of uplink throughput data, downlink throughput data, and power efficiency data,
obtaining, by the user equipment, second weights for the continuous action agent based on the reward function,
updating, by the user equipment, the discrete action agent based on the first weights, and updating, by the user equipment, the continuous action agent based on the second weights.

18. A non-transitory machine-readable medium, comprising executable instructions that, when executed by at least one processor of a user equipment, facilitate performance of operations, the operations comprising:
obtaining environment state data comprising reference signal data transmitted from a base station to the user equipment;
inputting the environment state data into a discrete action agent neural network model;
obtaining, in response to the inputting of the environment state data into the discrete action agent neural network model, a precoding matrix and channel state information matrices;
inputting combined state data comprising the environment state data, the precoding matrix and the channel state information matrices, into a continuous action agent-based neural network model;
obtaining, in response to the inputting of the combined state data into the continuous action agent-based neural network model, a precoding matrix indicator, a rank indicator, and a channel quality indicator value; and
communicating channel state information report data, comprising the precoding matrix, the channel state information matrices, the precoding matrix indicator, the rank indicator, and the channel quality indicator value, to the base station.

19. The non-transitory machine-readable medium of claim 18, wherein the operations further comprise obtaining first weights for the discrete action agent neural network model learned via offline training in a server external to the user equipment, obtaining second weights for the continuous action agent-based neural network model learned via the offline training in the server, updating the discrete action agent neural network model based on the first weights, and updating the continuous action agent-based neural network model based on the second weights.

20. The non-transitory machine-readable medium of claim 18, wherein the environment state data comprises first environment state data comprising first reference signal data, wherein the precoding matrix comprises a first precoding matrix, wherein the channel state information matrices are first channel state information matrices, wherein the combined state data comprises first combined state data, wherein the precoding matrix indicator comprises a first precoding matrix indicator, wherein the rank indicator comprises a first rank indicator, wherein the channel quality indicator value comprises a first channel quality indicator value, wherein the channel state information report data comprises first channel state information report data, and wherein the operations further comprise:
obtaining second environment state data comprising second reference signal data transmitted from the base station to the user equipment;
inputting the second environment state data into the discrete action agent neural network model;
obtaining, in response to the inputting of the second environment state data into the discrete action agent neural network model, a second precoding matrix and second channel state information matrices;
inputting second combined state data comprising the second environment state data, the second precoding matrix and the second channel state information matrices, into the continuous action agent-based neural network model;
obtaining, in response to the inputting of the second combined state data into the continuous action agent-based neural network model, a second precoding matrix indicator, a second rank indicator, and a second channel quality indicator value; and
communicating second channel state information report data, comprising the second precoding matrix, the second channel state information matrices, the second precoding matrix indicator, the second rank indicator, and the second channel quality indicator value, to the base station.
